(19) United States
(12) Patent Application Publication
(10) Pub. No.: US 2025/0145419 A1
(43) Pub. Date: May 8, 2025

(54) LIFTING RIGGING

(71) Applicant: Siemens Gamesa Renewable Energy A/S, Brande (DK)

(72) Inventors: Frederik Jul Bertelsen, Vejle (DK); Marc Artur Sotos Richard, Vejle (DK); Michael Bramm, Brørup (DK); John Hansen, Skive (DK); Soeren Pedersen, Odense N (DK)

(21) Appl. No.: 18/726,208

(22) PCT Filed: Dec. 19, 2022
(86) PCT No.: PCT/EP2022/086629

§ 371 Date: Jul. 2, 2024

(30) Foreign Application Priority Data
Jan. 10, 2022 (EP) 22150802.1

(51) Int. Cl. B66C 1/10; B66C 23/02

(52) U.S. Cl. CPC B66C 1/10; B66C 23/022

(57) ABSTRACT

A lifting rigging is provided including a yoke adapted for connection between a load and a suspension point; and a weight-bearing assembly mounted on the yoke, which weight-bearing assembly includes a spring module including a number of constant torque springs, and a yoke wire with a first end adapted for connection to the suspension point and a second end connected to the spring module and adapted to wind the constant torque springs when the yoke wire is subject to a pulling force, and wherein the weight-bearing assembly is configured such that the yoke wire bears the weight of the yoke when the lifting rigging is suspended from the suspension point.

### CROSS-REFERENCE TO RELATED APPLICATIONS

This application is a national stage of PCT Application No. PCT/EP2022/086629, having a filing date of Dec. 19, 2022, claiming priority to EP Application Serial No. 22150802.1, having a filing date of Jan. 10, 2022, the entire both contents of which are hereby incorporated by reference.

### FIELD OF TECHNOLOGY

The following invention relates to a lifting rigging.

### BACKGROUND

Components of a wind turbine generator may be assembled in a factory setting to obtain a pre-assembly for installation at the wind turbine site. For example, a switchgear unit may need to be lifted onto the upper level of a bedframe structure, which can later be lifted to the height of the nacelle during an installation procedure. Such assembly procedures are generally carried out in a confined space, i.e., the ceiling height determines the type of crane that can be used and determines the available lifting height. In a factory environment therefore, it is usual to deploy a column-mounted slewing crane. The column of such a crane is secured to the floor, and its swivel arm can be used to lift and move a load within a restricted area. The lifting height is limited by the height of the crane column. The low ceiling in a typical assembly hall or factory setting allows only short lifting chains or cables, which amplifies the problem arising from the difference between center of gravity of the yoke alone, and center of gravity of the combined yoke and load.

When using a column-mounted slewing crane to lift a heavy load, the load is first connected using load lines (wires, slings, chains or cables) to a beam or yoke, and the yoke is connected using hook lines (wires, chains or cables) to a crane hook. A yoke in the form of a straight beam can be used to lift a “simple” load, for example a component with a straightforward cuboid shape and a center of mass that essentially coincides with the center of geometry. In this case, the crane hook will be positioned above the combined center of mass of load and yoke, and the lifting procedure is straightforward, without any tilting of the yoke in the initial stages of lifting, and with even distribution of weight in the hook lines and load lines at all times.

However, in the case of a complicated load shape and/or a very heavy load, a straight beam is unsuitable as a yoke. Instead, the yoke may have a T-shape with a long main beam and a shorter beam extending at a right angle from the main beam. Three lifting lines are used to connect the T-shaped yoke to the crane hook, and three further lines are used to connect the yoke to the load. The lengths of the yoke lines and the load lines must be such that all lines are taut at the instant when the load is lifted off the ground. A problem with this arrangement is that the center of mass of the T-shaped yoke is to one side of the main beam so that, in the initial lifting stage, the yoke will tilt owing to its offset center of mass. This makes it difficult to connect the load lines between yoke and load. Furthermore, since not all yoke lines are taut at this stage, the unbalanced yoke may oscillate and may strike the component, resulting in damage. The unpredictable swaying of the yoke may also present a hazard to personnel in the vicinity.

For this reason, lifting such a heavy load in a confined space is generally performed using two cranes, and the cranes are synchronized to share the weight of the load in such a way that the component does not tilt. The need to deploy two cranes to lift a single component adds to the overall cost of assembly, and it can be time-consuming to connect the load to both cranes. Alternatively, for each type of load to be lifted, a dedicated yoke may be constructed with a shape that places its center of mass over the center of mass of the load. However, the need to construct a dedicated yoke for each load shape also adds to the overall manufacturing costs. In one possible alternative to using two cranes, a chain hoist might be connected at a suitable position on a T-shaped yoke. The chain hoist could be manually operated by personnel during the early stages of a lifting procedure to keep the yoke balanced until the load is connected to the yoke. However, this approach requires the additional steps of attaching the chain hoist between the yoke and the crane, and a technician must be available to actuate the chain hoist while another technician attaches the load slings between yoke and load.

### SUMMARY

This aspect is achieved by the claimed lifting rigging and by the claimed method of lifting a load.

An aspect relates to a lifting rigging (or “lifting gear”) that is particularly suited for lifting a heavy and unwieldy load such as a wind turbine component over a short distance in a factory environment.

According to embodiments of the invention, the lifting rigging comprises a yoke adapted for connection between a load and a suspension point such as a crane hook. The lifting rigging further comprises a weight-bearing assembly mounted on the yoke, which weight-bearing assembly comprises a spring module comprising a number of constant torque springs, and a yoke wire with a first end adapted for connection to the suspension point and a second end connected to the spring module and adapted to wind the constant torque springs when the yoke wire is subject to a pulling force. The weight-bearing assembly is configured such that the fully-extended yoke wire bears the weight of the yoke when the lifting rigging is suspended from the suspension point.

The lifting rigging shall also comprise fittings to which hook lines can be secured, and which can be arranged at a suitable positions on the yoke. The hook lines extend from the yoke to the crane hook and are required to transfer lifting forces to the crane hook when the load is suspended in the air. The hook lines shall be understood to comprise any suitable cable, chain, strap, sling, wire etc., with an appropriate material thickness and tensile strength. In an embodiment, a T-shaped yoke will be equipped with fittings to receive three hook lines of equal length. Similarly, the lifting rigging also comprises fittings to receive load lines that are connected to the load. The load lines are required to transfer lifting forces to the yoke, and shall be understood to comprise any suitable cable, chain, strap, sling, wire etc., with an appropriate material thickness and tensile strength. A load line lifting fitting can be a downward-pointing eyelet for example, mounted at the outer end of a beam.

In embodiments of the invention, an aspect of the lifting rigging is that the weight-bearing assembly is calibrated to the weight of the yoke, i.e., the yoke wire will carry the weight of the yoke and any components or fittings mounted to the yoke. Therefore, when the crane hook is raised in the initial stage of a load lifting procedure, the yoke wire is gradually extended until it reaches its full length or “calibration length”, at which point the yoke is suspended from the suspension point, but the load is still resting on the ground. Even though one or more of the hook wires may still be slack, the yoke is suspended horizontally and in a stable fashion by the weight-bearing assembly.

A constant torque spring shall be understood to comprise a pre-stressed band of steel with a first end wound about a storage drum and a terminal end wound about an output drum. The steel band can be wound on the storage drum and the output drum in an “S-configuration”, i.e., the output drum and storage drum rotate in opposite directions. Equally, the steel band can be wound on the storage drum and the output drum in a “B-configuration”, i.e., the output drum and storage drum rotate in the same direction. A spring module of the weight-bearing assembly of the inventive lifting rigging may comprise several such constant torque springs, and the terminal ends of a group of constant torque springs may be wound on a shared or common output drum.

According to embodiments of the invention, the method comprises the steps of providing a crane; connecting the first end of the yoke wire of the weight-bearing assembly to the crane hook; connecting hook lines between the yoke and the suspension point; connecting load lines between the yoke and the load; operating the crane to raise the hook, thereby exerting a pulling force on the yoke wire until the weight of the yoke is carried by the yoke wire; and subsequently operating the crane to raise the hook further in order to lift the load off the ground.

The inventive method ensures that the position of the crane hook is shifted seamlessly to a position directly above the center of mass (COM) of the load. This has the effect that the yoke remains level during lifting, regardless of the offset between yoke COM and load COM. The inventive method can be performed to lift large and unwieldy heavy loads even in confined spaces that afford only limited headroom for operating a crane.

In an embodiment, the crane is a column-mounted slewing crane. This type of crane is relatively economical and can be deployed in height-restricted settings to move a load from one position to another within a space defined by the radius of the slewing arm of the crane.

In an embodiment, the load to be lifted is large and unwieldy, and that the yoke is essentially T-shaped so that three hook lines can be connected between the yoke and the crane hook.

In an embodiment of the invention, the T-shaped yoke comprises a main beam and a detachable extension beam. The weight-bearing assembly of the lifting rigging is mounted to the extension beam. The extension beam can be detached from the main beam so that the main beam can be used on its own to lift a simple load.

The lifting rigging further comprises a plurality of hook lines for connecting the yoke to the suspension point, comprising three hook lines. These can be chains of suitable thickness, for example. The lengths of the hook lines are established in advance of the lifting maneuver and are chosen on the basis of the calibration length of the yoke wire of the weight-bearing assembly. The calibration length of the yoke wire determines the vertical distance between the crane hook and the yoke, and therefore also determines the length of each hook line between its yoke fitting and the crane hook.

The lifting rigging further comprises a plurality of load lines for connecting the yoke to the load. These can also be chains of suitable thickness, for example.

In an embodiment, when the crane hook is initially raised to pull on the yoke wire to its calibration length, the suspended yoke is held in a stable fashion by the weight-bearing assembly. To this end, the lifting rigging also comprises a yoke wire guide that is mounted on the yoke at a distance from the spring module and which defines the point of departure of the yoke wire from the yoke. The yoke wire guide is adapted to horizontally constrain the yoke wire over an initial portion of its path between the spring module and its point of departure from the yoke in the direction of the hook. In other words, the path of the yoke wire comprises two straight sections: a first horizontal section between the spring module and the guide, and a second variable section between the guide and the crane hook. Initially, the position of the crane can be above the guide. As the crane hook is raised, the crane can be operated to also move the hook towards a position over the COM of the load. For any load with a COM that is not underneath the guide, the second variable section of the yoke wire will be inclined at an angle. Therefore, in an embodiment of the invention, the yoke wire guide is realized as a hinged sheave which allows the yoke wire to assume any angle as the crane hook is moved during the lifting procedure.

In an embodiment, the guide is mounted to the yoke so that the point of departure of the yoke wire is aligned with the center of mass of the yoke. In other words, from the point of view of the crane hook, the yoke wire appears to originate from the center of mass of the yoke.

In an embodiment, the terminal end of a constant torque spring is wound on a rotatable output drum arranged in the spring module, and the output drum is turned by the yoke wire in reaction to the pulling force. The output drum of a cluster of identical constant torque springs is mounted on an axle at the center of a spring module. A pulling force on the yoke wire turns the axle to wind the terminal ends of the constant torque springs, thereby increasing the tensile force in the yoke wire. In an embodiment of the invention, a spring module comprises a cluster of at least six, or at least eight constant torque springs.

In an embodiment, the second end of the yoke wire is wound about a rotatable spool mounted on the yoke. In an embodiment of the invention, the yoke wire spool can be directly connected to the axle of an output drum of a spring module. However, the load capacity of a torque spring depends on its physical dimensions (drum diameters, width and length of steel band, etc.), so that if relatively small torque springs are to be used, a greater number is required in order to achieve the desired effect. Therefore, in an embodiment of the invention, the weight-bearing assembly further comprises a gear arrangement between the yoke wire spool and the output drum axle. The gear arrangement can convert a rotation of the spool into a rotation of the output drum of a spring module. With a gear arrangement between yoke wire spool and output drum axle, the spring module can be realized with a favorably small number of torque springs, and the spring module can be realized as a favorably compact unit.

In an embodiment of the invention, the weight-bearing assembly comprises a pair of spring modules arranged symmetrically about the yoke, and the yoke wire spool is rotatably coupled to the output drum axle of each spring module either directly or, as explained above, by a gear arrangement.

In an embodiment, the method comprises a prior step of calibrating the weight-bearing assembly to the weight of the yoke. In such a calibration step, the position of the center of mass of the yoke is estimated or computed, and the guide is mounted to the yoke accordingly.

In an embodiment of the invention, the method comprises a step of arranging hook line lifting fittings on the yoke. The positions of the lifting fittings may be adjusted on the basis of the hook line lengths and the position of the COM of the load relative to the yoke.

### BRIEF DESCRIPTION

Some of the embodiments will be described in detail, with reference to the following Figures, wherein like designations denote like members.

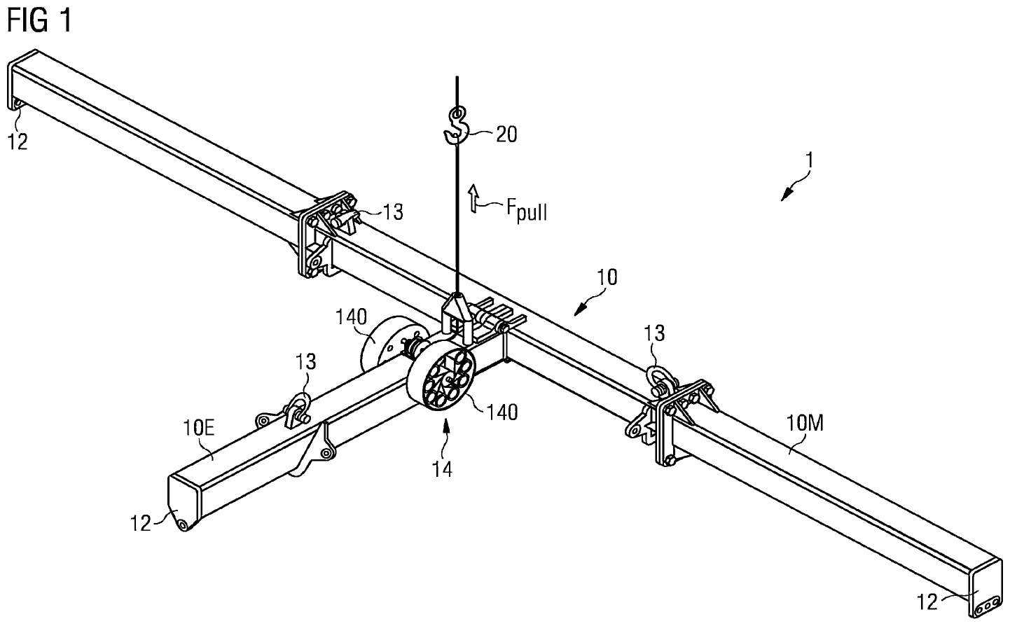

FIG. 1 shows an exemplary embodiment of the inventive lifting rigging;

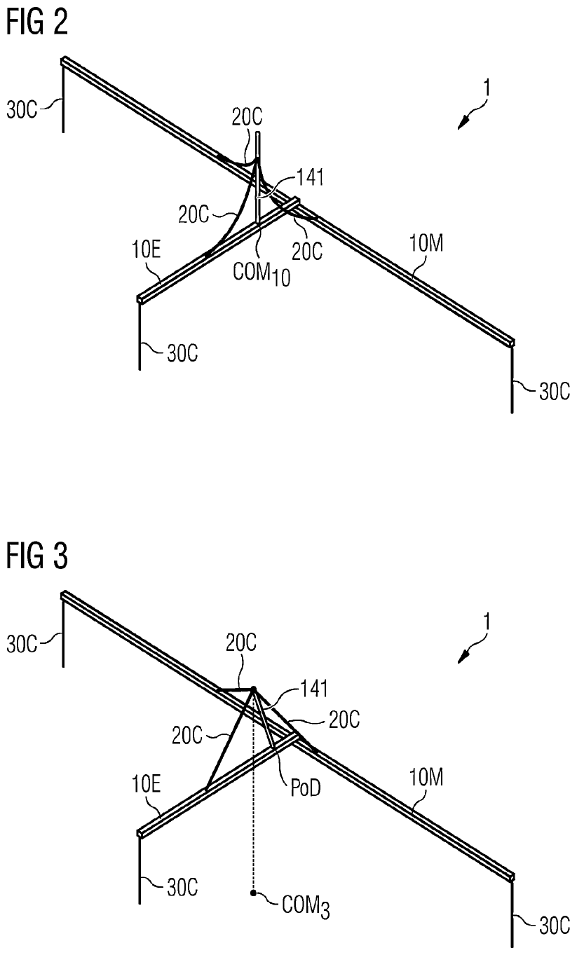

FIG. 2 illustrates the concept of the inventive lifting rigging;

FIG. 3 illustrates the concept of the inventive lifting rigging;

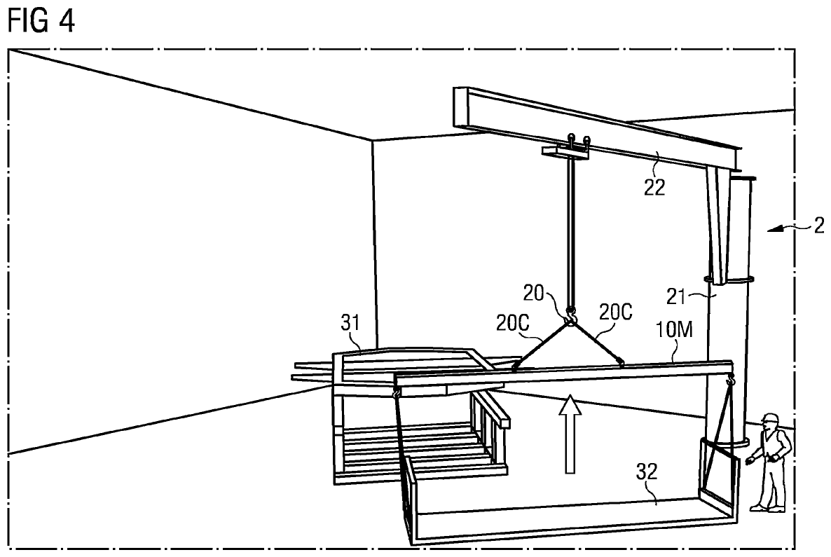

FIG. 4 illustrates steps of the inventive lifting method;

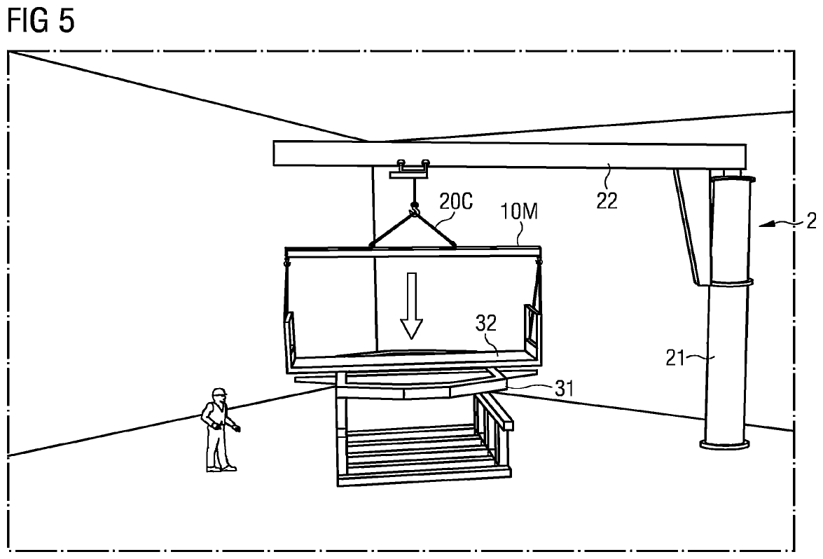

FIG. 5 illustrates steps of the inventive lifting method;

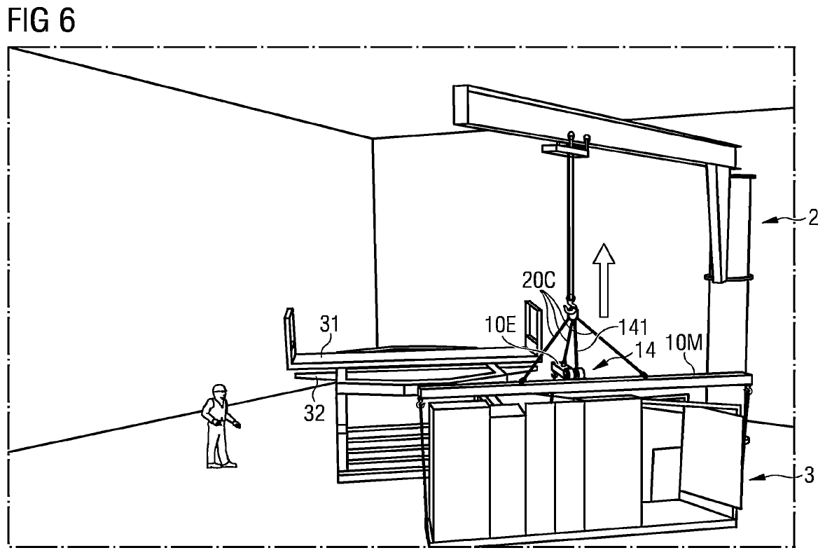

FIG. 6 illustrates steps of the inventive lifting method;

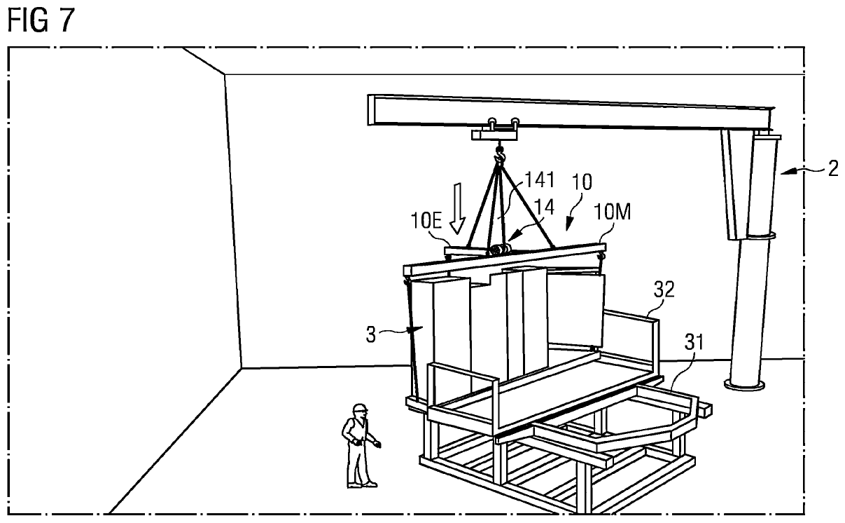

FIG. 7 illustrates steps of the inventive lifting method;

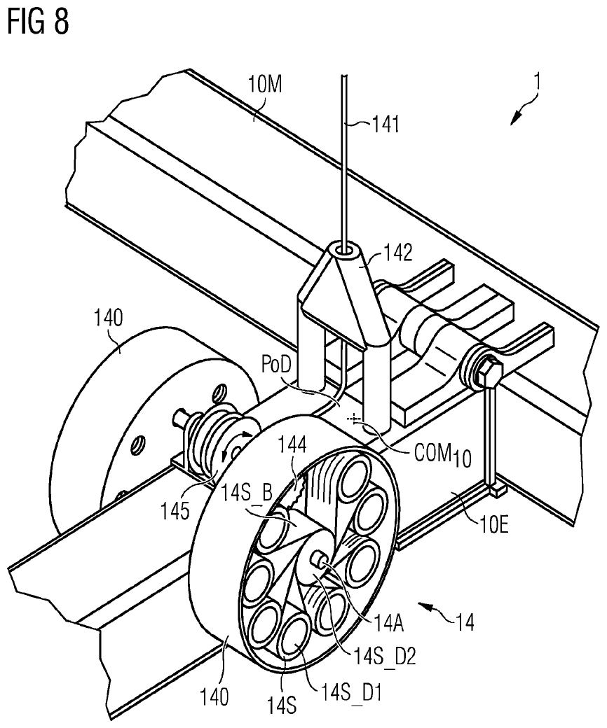

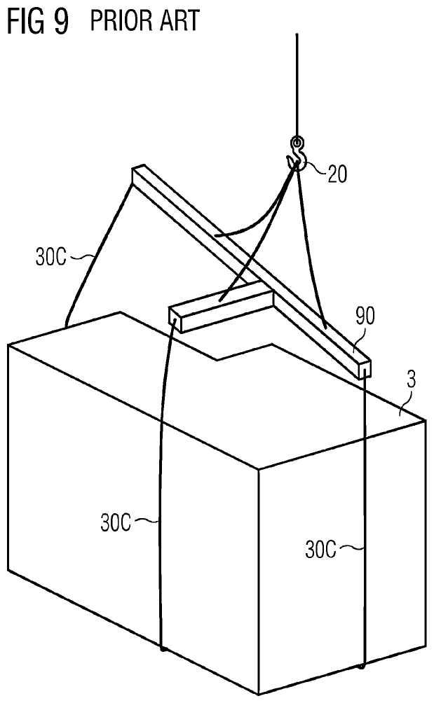

FIG. 8 shows details of the weight-bearing assembly in an embodiment of the inventive lifting rigging;

FIG. 9 shows a conventional art approach; and

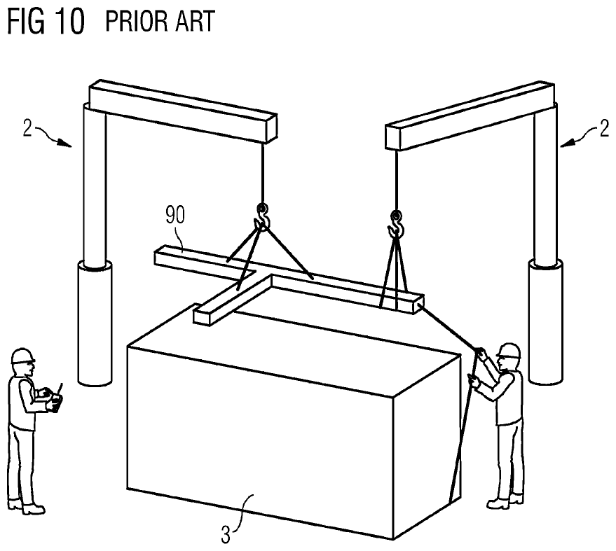

FIG. 10 shows a further conventional art approach.

### DETAILED DESCRIPTION

As explained above, a load can be connected to a yoke using any suitable cables, chains, slings etc. Similarly, the yoke can be connected to a crane hook using any suitable cables, chains, slings etc. For the sake of simplicity, the following description refers to the use of chains for this purpose.

FIG. 1 shows an exemplary embodiment of the inventive lifting rigging 1. The diagram shows a T-shaped yoke 10 comprising a main beam 10M and an extension beam 10E detachably connected to the main beam 10M. The extension beam 10E is connected to the main beam 10M at its midpoint. At the outer ends of the “T”, lifting fittings 12 are provided to allow a load (not shown) to be connected to the yoke 10 by suitable chains. Further fittings 13 are attached to the main beam 10M and extension beam 10E to allow the yoke 10 to be connected to a chain hook 20 using three suitable chains (not shown). The drawing shows a weight-bearing assembly 14 mounted to the extension beam 10E. The weight-bearing assembly 14 comprises two spring modules 140, each enclosing a cluster of constant torque springs 14S, and a yoke wire 141 with a first end that can be attached to the crane hook 20. The second end of the yoke wire 141 is connected to the spring modules 140 such that the constant torque springs 14S are wound about an output drum when the yoke wire 141 is subject to a pulling force Fₚᵤₗₗ.

The yoke wire 141 passes through a wire guide 142, in this case a hinged sheave, mounted to the extension beam 10E. The hinged sheave 142 allows the yoke wire 141 to adopt essentially any angle when the crane hook 20 is moved relative to the yoke 10.

The weight-bearing assembly 14 is configured such that the yoke wire 141 bears the weight of the yoke 10 when the lifting rigging 1 is suspended from the crane hook 20, as will be explained in the following.

FIG. 2 and FIG. 3 are line drawings to illustrate the concept of the inventive lifting rigging 1 and indicate the main beam 10M and the extension beam 10E of a T-shape yoke 10 connected at right angles as shown in FIG. 1. FIG. 2 illustrates a first stage in a load lifting procedure, in which the load (not shown) is resting on the ground prior to being lifted. Three load chains 30C are connected to the load and to the yoke at fittings at the outer ends of the yoke 10. Three hook chains 20C are attached to the crane hook (not shown). The yoke wire 141 is also attached to the crane hook, so that all three hook chains 20C and the yoke wire 141 meet at the same point.

Initially, yoke wire 141 is wound on a spool with only a short length extending for connection to the crane hook 20, and the hook chains 20C are slack. The crane hook 20 is attached to the hook wire 141 and can be in a position above the COM₁₀ of the yoke. The crane is then operated to raise the hook. This results in a pulling force Fₚᵤₗₗ on the yoke wire 141, which in turn causes rotation of the spool and causes the constant torque springs in spring module 14 to be wound on the output drum. As the pulling force Fₚᵤₗₗ on the yoke wire 141 increases, the length of the yoke wire 141 also increases as it is unwound from its spool. The weight-bearing assembly 14 is calibrated so that the yoke wire 141 reaches its calibration length or full extension when the weight of the lifting rigging is carried by the yoke wire 141. The yoke 10 can now be raised further, and it will maintain its horizontal orientation in space even though the load is still resting on the ground. The hook chains 20C are not yet loaded, since the weight of the yoke is carried by the yoke wire 141. The hook chains 20C will bring the crane hook to a position above the COM₃ of the load.

As the crane hook is raised further, the load chains 30C also become taut, and ultimately the load will be raised off the ground. At this point, the weight of the load is transferred to the crane hook 20 through the load chains 30C and the hook chains 20C. The crane hook 20 stays in position above the COM₃ of the load as indicated by the vertical dotted line.

FIGS. 4-7 illustrate steps in a component assembly procedure. In this exemplary sequence, a switchgear unit of a wind turbine generator is to be lifted onto a bedframe. The procedure is performed in a factory environment, and the type of crane that can be used is limited by the ceiling height. The crane 2 shown is known as a column-mounted slewing crane and comprises a swivel arm 22 that can transfer loads within a certain action radius.

In a first stage as shown in FIG. 4, the main beam 10M is used on its own to transfer a switchgear floor unit 32 onto the bedframe 31. This relatively simple piece of equipment has a straightforward shape so that its center of mass lies essentially underneath the center of mass of the main beam 10M during the lifting procedure as shown in FIG. 4 and FIG. 5.

In a second stage, the heavy switchgear unit 3 is to be lifted into place onto the switchgear floor unit 32. This lifting procedure is more critical. Even if it were possible to identify the exact position of the center of mass COM₃ of the switchgear unit 3, it would be too difficult to ensure that this point always lies exactly beneath the center of mass of a simple straight beam 10M. Therefore, as shown in FIG. 3, the inventive lifting rigging 1 is assembled by attaching the extension beam 10E (with spring unit 14) to the main beam 10M as described in FIG. 1 above.

After connecting the crane hook 20 to the T-shaped yoke 10 using three chains 20C and connecting the yoke wire 141 to the hook 20, the crane is operated to slowly raise the hook 20. This action exerts a pulling force Fₚᵤₗₗ on the yoke wire 141 as explained above, unwinding it from the spool towards its calibration length. At the instant when load 3 is lifted completely off the ground, the three hook chains 20C are taut, but the tensile force in the yoke wire 141 is no greater than it would be if only the yoke 10 were being lifted. The weight of the load 3 is transferred to the hook 20 only through the load chains 30C and the hook chains 20C. The center of mass COM₃ of load 3 is directly underneath the crane hook 20, and the yoke 10 remains steady during the entire lifting maneuver.

FIG. 8 shows a perspective view of weight-bearing assembly 14 in an exemplary embodiment of the inventive lifting rigging 1. The diagram shows two spring modules 140 in a symmetric arrangement about the extension beam 10E. Each spring module 140 houses a cluster of constant torque springs 14S, each comprising a prestressed steel band wound on a storage drum 14S_D1. The terminal ends of the constant torque springs 14S of a cluster are attached to a common output drum 14S_D2. The output drum 14S_D2 of a spring module 140 is mounted to a shaft or axle 14A, which is turned by a gear of a gear arrangement 144. The yoke wire 141 is initially wound on a spool 143, and is unwound by a pulling force Fₚᵤₗₗ, thereby turning the spool 143 and the output drum 14S_D2, so that the constant torque springs 14S are unwound onto the output drum 14S_D2. The constant torque springs 14S therefore act against the pulling force Fₚᵤₗₗ.

The diagram also shows a wire guide or hinged sheave 142 arranged to constrain the first section of the yoke wire 141 and to determine the point at which the yoke wire 141 “departs” from the yoke. Guide 142 is mounted at a point that is aligned with the center of mass of the yoke 10, so that the yoke wire 141 (from the point of view of the hook) appears to originate from the center of mass COM₁₀ of the yoke 10. As a result, the yoke 10 will remain essentially horizontal when lifted into the air as described above.

FIG. 9 illustrates the result of lifting the same load 3 using only a T-shaped yoke 90 suspended from a single crane 2. The T-shaped yoke 90 is desired, since it is relatively cheap and allows a load to attached using three chains 30C. Here, the hook chains 20C are connected to suspend the irregularly-shaped load 3 correctly when the load 3 is in the air, and as a result the center of mass of the yoke 90 is required to be offset to one side. As a result, as soon as the yoke 90 is lifted into the air, it is off-kilter and tilts accordingly as shown in the drawing and can sway unpredictably while being raised further until the load chains become taut. The swaying yoke 90 can be hazardous to personnel, and collision between the heavy yoke and the load 3 can lead to damage. A further undesirable outcome is the failure of a yoke cable 20C during the lifting maneuver.

FIG. 10 shows the usual conventional art approach to avoid the highly undesirable outcome described in FIG. 9. Load 3 is managed by two cranes which are controlled to shift the weight of the load 3 as it is hoisted towards its target position.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A lifting rigging comprising:
a yoke configured for connection between a load and a suspension point; and
a weight-bearing assembly mounted on the yoke, which weight-bearing assembly comprises:
a spring module comprising a number of constant torque springs, and
a yoke wire with a first end configured for connection to the suspension point and a second end connected to the spring module and configured to wind the constant torque springs when the yoke wire is subject to a pulling force, and wherein the weight-bearing assembly is configured such that the yoke wire bears the weight of the yoke when the lifting rigging is suspended from the suspension point.

2. The lifting rigging according to claim 1, comprising a plurality of hook lines for connecting the yoke to the suspension point and a plurality of load lines for connecting the yoke to the load.

3. The lifting rigging according to claim 1, comprising a yoke wire guide configured to horizontally constrain the yoke wire between the spring module and a point of departure from the yoke.

4. The lifting rigging according to according to claim 3, wherein the point of departure is aligned with the center of mass of the yoke.

5. The lifting rigging according to claim 1, wherein the yoke wire guide is a hinged sheave.

6. The lifting rigging according claim 1, wherein the terminal end of a constant torque spring is wound on a rotatable output drum arranged in the spring module, which output drum is turned by the yoke wire in reaction to the pulling force.

7. The lifting rigging according to claim 1, wherein a spring module comprises a plurality of constant torque springs.

8. The lifting rigging according to claim 1, wherein the weight-bearing assembly comprises a pair of spring modules arranged symmetrically about the yoke.

9. The lifting rigging according to claim 1, wherein the second end of the yoke wire is wound about a rotatable spool mounted on the yoke to wind and unwind the yoke wire, and wherein the weight-bearing assembly further comprises a gear assembly configured to convert a rotation of the spool into a rotation of an output drum of a spring module.

10. The lifting rigging according to claim 1, wherein the yoke is essentially T-shaped and comprises a main beam and an extension beam connected to the main beam, and wherein the weight-bearing assembly is mounted to the extension beam.

11. The lifting rigging according to claim 10, wherein the extension beam of the yoke is detachable from the main beam.

12. The method of lifting a load using the lifting rigging of claim 1, which method comprises:
providing a crane;
connecting the first end of the yoke wire of the weight-bearing assembly to a suspension point of the crane;
connecting hook lines between the yoke and the suspension point;
connecting load lines between the yoke and the load;
operating the crane to raise the suspension point, thereby exerting a pulling force on the yoke wire until the weight of the yoke is carried by the yoke wire; and
subsequently operating the crane to raise the suspension point further in order to lift the load off the ground.

13. The method according to claim 12, comprising a prior step of calibrating the weight-bearing assembly to the weight of the yoke.

14. The method according to claim 12, comprising a prior step of assembling the lifting rigging according to the geometry of the load.

15. The method according to claim 12, wherein the crane is a column-mounted slewing crane.
